(19) United States
(12) Patent Application Publication
(10) Pub. No.: US 2005/0108662 A1
(43) Pub. Date: May 19, 2005

(54) Microprocessor system

(76) Inventors: Alistair Morfey, Cambridge (GB); Timothy James Ramsdale, Cambridge (GB); Richard Penry Williams, Cambridge (GB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/497,698

(22) PCT Filed: Dec. 4, 2002
(86) PCT No.: PCT/GB02/05428

(30) Foreign Application Priority Data
Dec. 5, 2001 (GB) 0129144.2

(51) Int. Cl. G06F 17/50

(52) U.S. Cl. 716/1

(57) ABSTRACT

A processor, suitable for embedded applications, is disclosed comprising a processor core and peripheral devices. One of these devices is a memory management unit allowing the designer of an application specific integrated circuit (ASIC) embodying the processor to tailor the interface between the processor and memory devices according to the intented memory configuration of the processor. Also disclosed is a computer-aided method of disigning such a processor, allowing a user to specify at descriptor level a Harvard or von Neuman memory interface between the processor and memory devices.

This invention relates to a method and apparatus for designing microprocessors and parts therefore which are suitable for, though not limited to, incorporation in an application-specific integrated circuit (ASIC).

In the present day, many products incorporate microprocessor based data processing circuits, for example to process signals, to control internal operation and/or to provide communications with users and external devices. To provide compact and economical solutions, particularly in mass-market portable products, it is known to include microprocessor functionality together with program and data storage and other specialised circuitry, in a custom “chip” also known as an ASIC.

However, for various reasons, the integrated microprocessor functionality conventionally available to a designer of an ASIC tends to be the same as that which would be provided by a microprocessor designed for use as a separate chip. The present inventors have recognised that this results in inefficient use of space and power in an ASIC and in fact renders many potential applications of ASIC technology impractical and/or uneconomic.

On the other hand, microprocessors that are intended for incorporation into ASICs typically do not offer the performance and functionality that is required by some modern applications.

The applicant's earlier case, WO 96/09583, addresses and provides solutions to many of these problems. The present application describes a memory management unit and an automated computer aided method of designing the particular configuration of the memory management unit that will be used in a particular chip design.

According to one aspect of the invention, there is provided a computer based method of designing a processor, the method comprising the steps of receiving a first file defining a logic arrangement of a processor core; receiving a second file defining a logic arrangement of a memory management unit, wherein the arrangement comprises both a Harvard interface and a von Neuman interface between the processor core and one or more memory devices; receiving a user file specifying either a Harvard or a von Neuman interface for the or each memory device associated with the processor; and processing the second data file in accordance with the user file to generate a third file defining a logic arrangement of the memory management unit in accordance with the user specification.

An exemplary embodiment of the present invention will now be described with reference to the accompanying drawings in which:

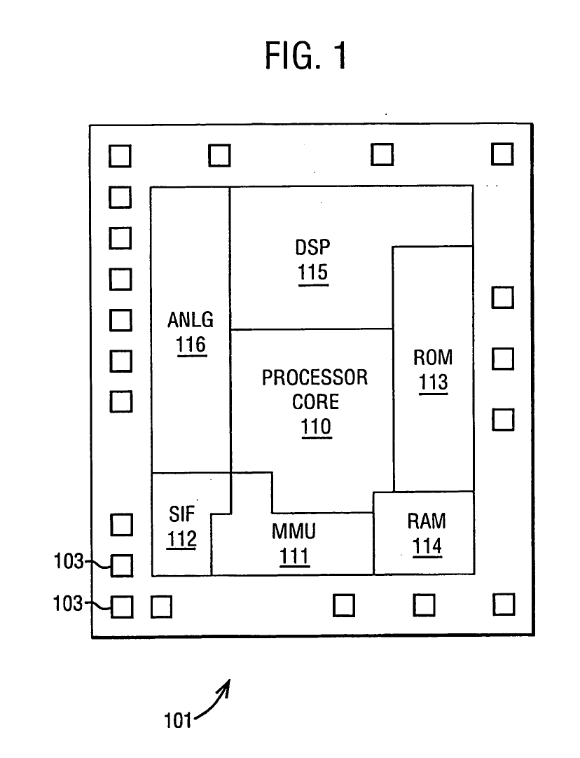

FIG. 1 shows the physical layout of an ASIC which incorporates a processor together with peripherals to form a processing system on the ASIC;

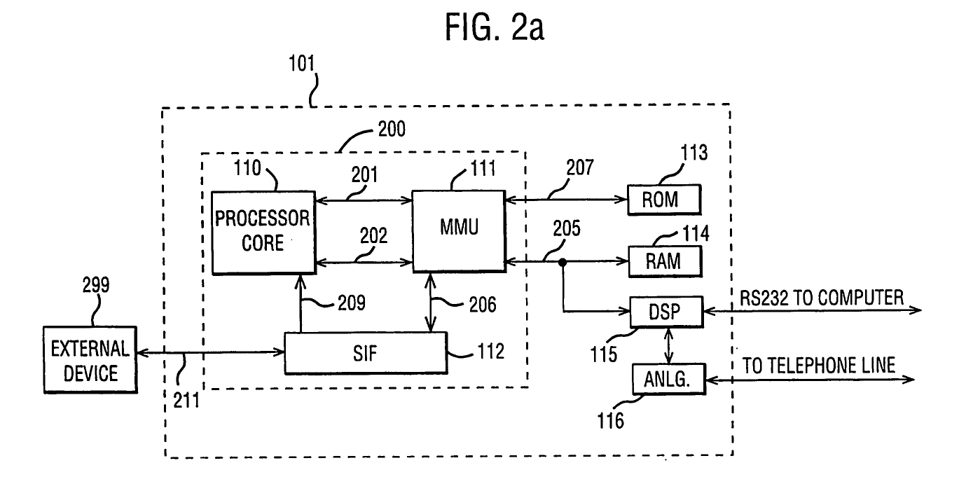

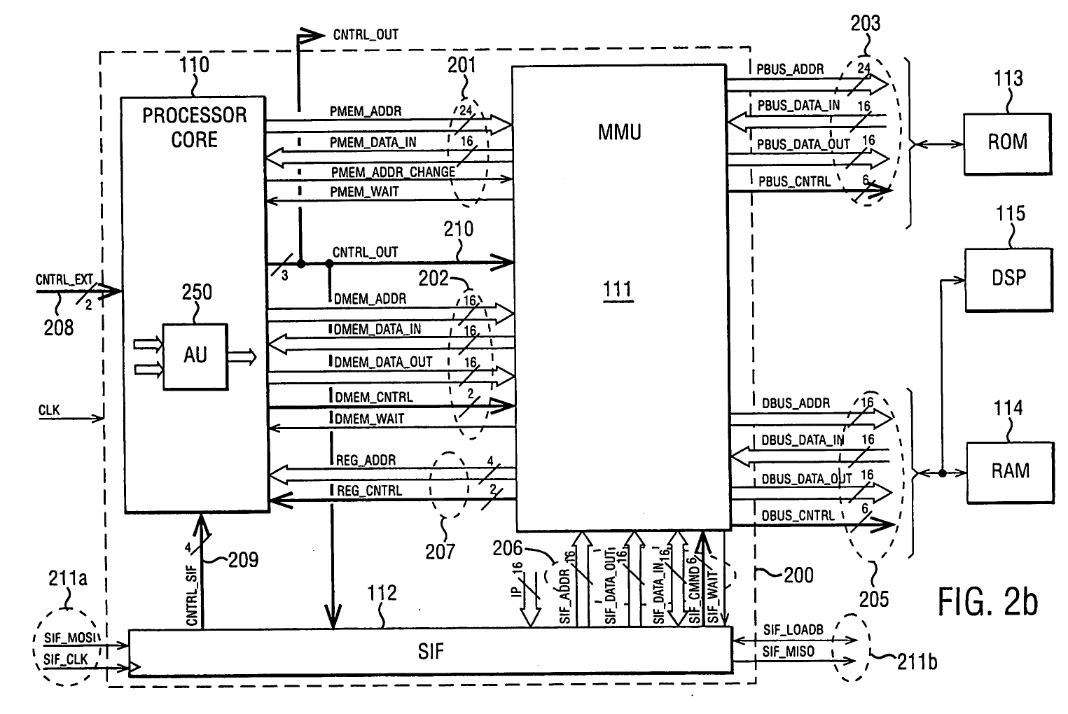

FIG. 2a is a block diagram of the ASIC of FIG. 1 together with an external device and illustrates the major functional blocks within the processor and how they interact with the ASIC;

FIG. 2b is a block diagram illustrating in more detail the main parts of the ASIC shown in FIG. 1;

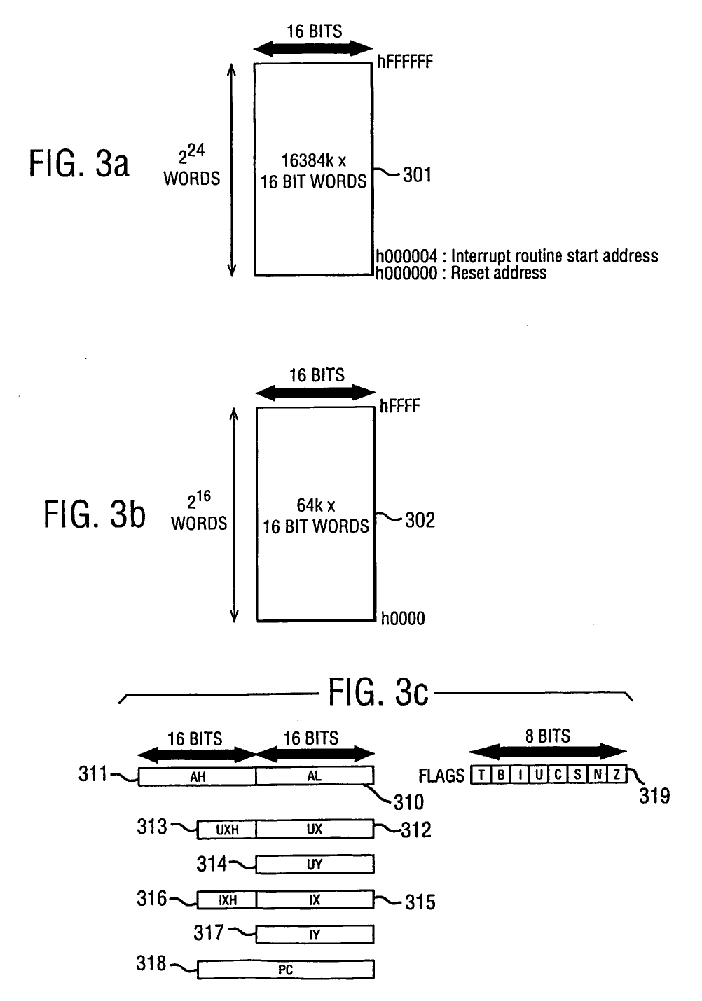

FIG. 3a illustrates the program space of the processor;

FIG. 3b illustrates the data space of the processor;

FIG. 3c illustrates the registers present within the processor;

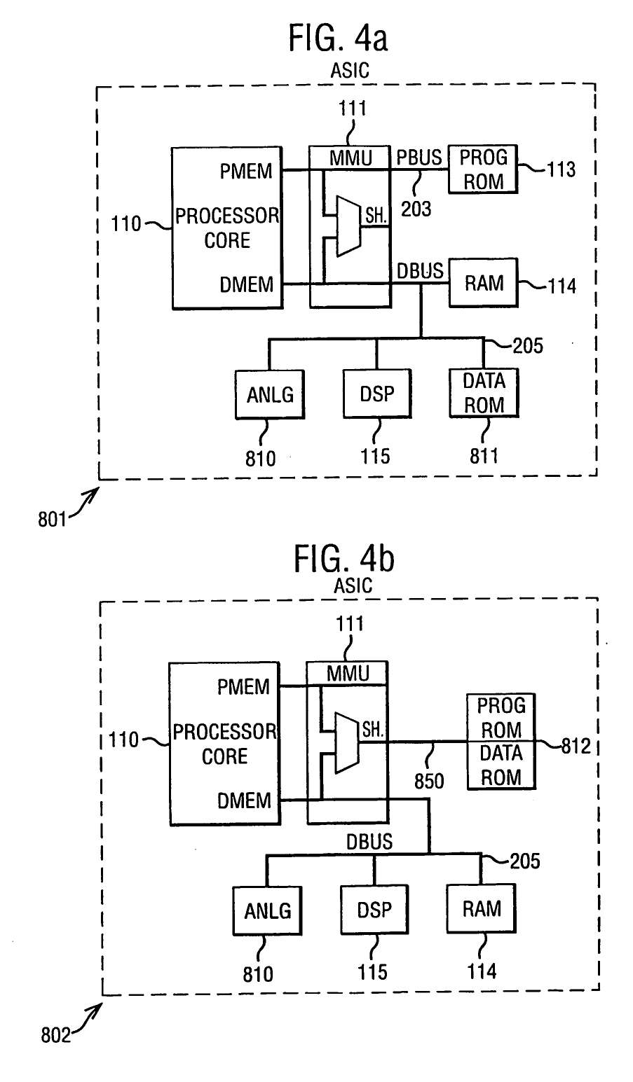

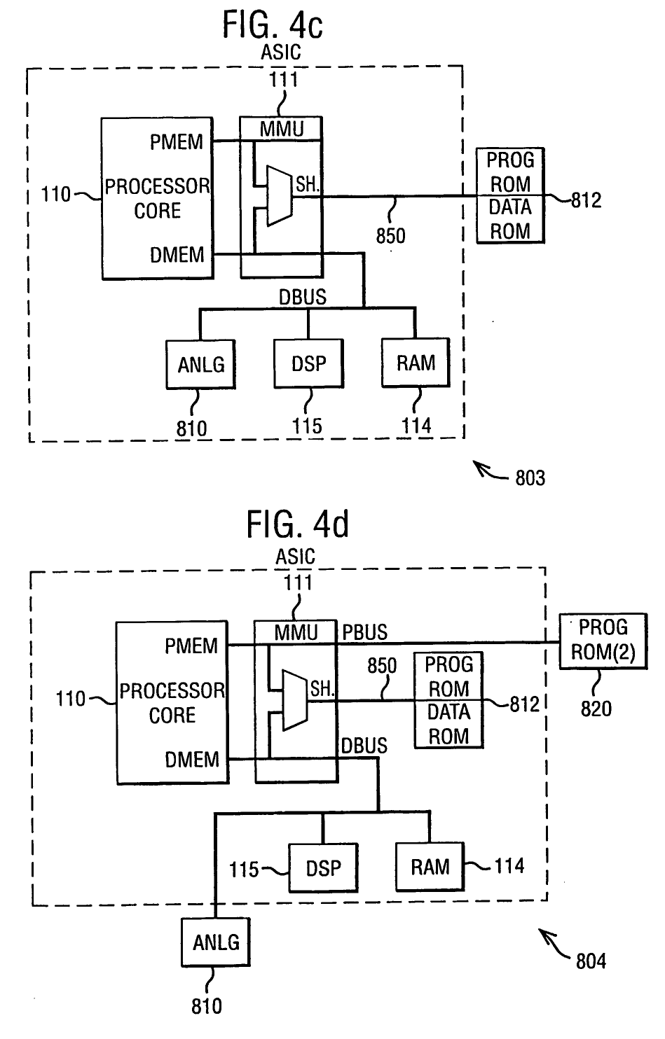

FIG. 4a is a block diagram of an ASIC having separate buses for the program space and data space;

FIG. 4b is a block diagram of an ASIC having a shared bus for the program space and for a portion of the data space;

FIG. 4c is a block diagram of an ASIC having a shared bus for the program space and for a portion of the data space, where the shared bus communicates with devices that are external to the ASIC;

FIG. 4d is a block diagram of an ASIC having a shared bus for a portion of the program space and a portion of the data space, where the shared bus communicates with devices that are external to the ASIC, and having data and program buses for communication with devices that are both internal and external to the ASIC;

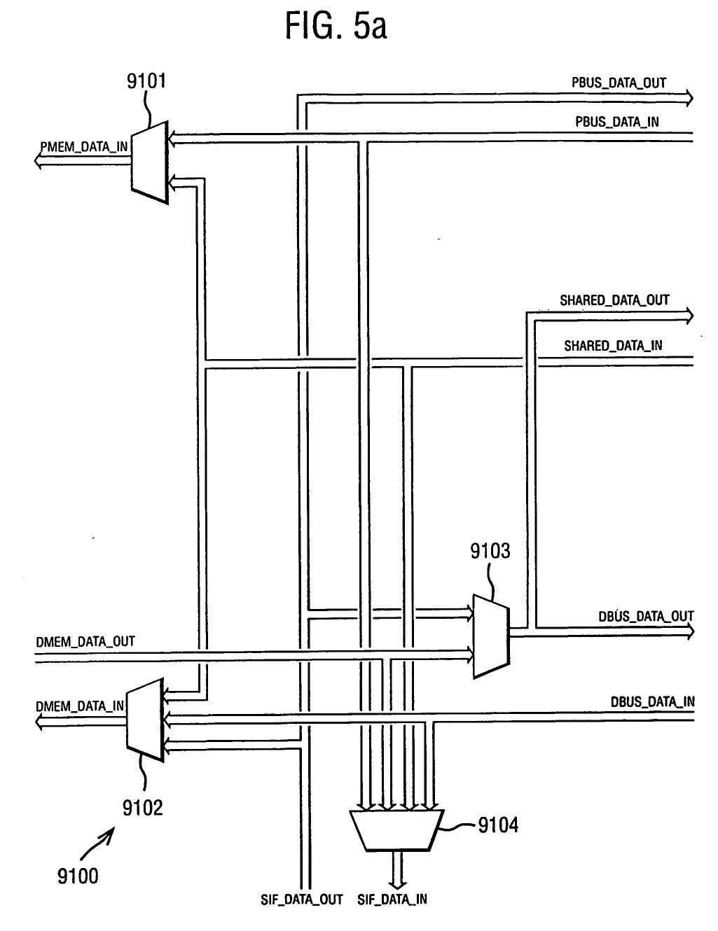

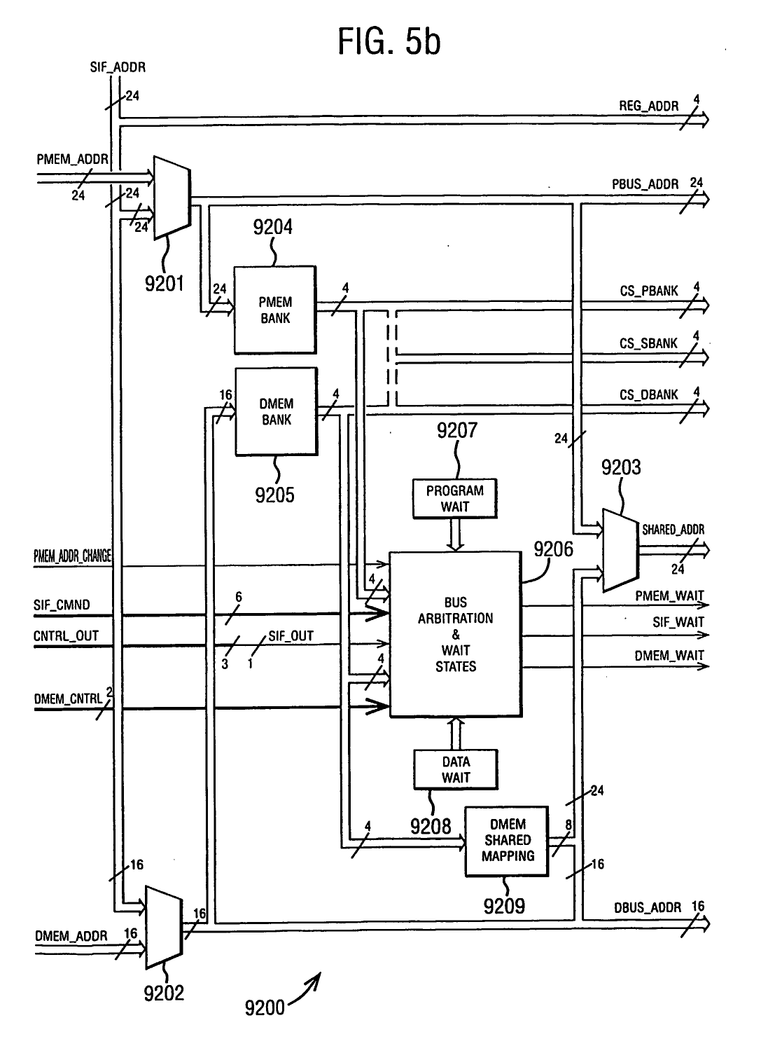

FIG. 5a is a schematic diagram illustrating data paths available through the MMU;

FIG. 5b is a block diagram of the MMU control logic; and

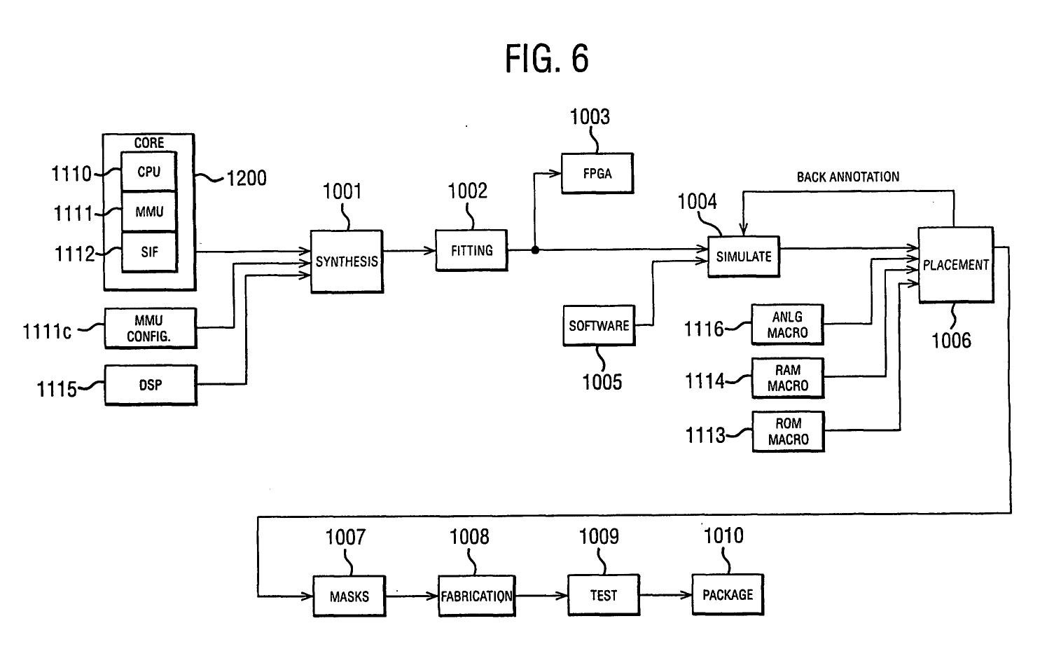

FIG. 6 is a block diagram illustrating the major steps required to manufacture an application specific integrated circuit.

The description which follows includes the following sections:
OVERVIEW
PROGRAMMER'S MODEL OF THE PROCESSOR
INSTRUCTION SET OF THE PROCESSOR
ADDRESSING MODES OF THE PROCESSOR
ARCHITECTURE OF THE PROCESSOR
EXTENDED PROGRAM SPACE
SERIAL INTERFACE (SIF)
ALTERNATIVE ARCHITECTURES
   MEMORY MANAGEMENT UNIT (MMU)—CONFIGURATION
   MEMORY MANAGEMENT UNIT (MMU)—CIRCUITRY
ASIC DESIGN PROCESS
FURTHER NOTES AND ALTERNATIVE EMBODIMENTS
   Overview

A processor lies at the heart of a computer system and is responsible for stepping through the instructions of a program in an orderly fashion, executing them, and controlling the operation of the computer's memory and input/output devices. For a general discussion of the architecture of a processor, the reader is referred, for example, to the book entitled “The Principles of Computer Hardware” Oxford Science Publication 1985.

The processor described herein comprises four distinct blocks:
(i) A processor core containing processor registers, address generators and instruction fetch and control logic;
(ii) an arithmetic unit, hereafter referred to as the AU, containing addition, subtraction, multiplication and division logic;
(iii) a memory management unit, hereafter referred to as the MMU, containing circuitry for interfacing the processor core to memory devices; and
(iv) a serial interface, hereafter referred to as the SIF, containing a shift register and control logic to allow external access to the processor core and memory devices.

The combination of these four blocks will hereafter be referred to as the processor. The processor is particularly suitable for integration as part of an ASIC or it may be provided as a separate processor chip.

FIG. 1 shows an ASIC 101 which incorporates the processor to be described in detail below. As shown the ASIC has a plurality of bond pads (two of which are referenced 103) for connecting circuitry of the ASIC off-chip. The circuitry of the ASIC 101 comprises: a processor core 110, an MMU 111, a SIF 112, a read only memory (ROM) 113 for storing the program to be executed by the processor core, a random access memory (RAM) 114 for storing data produced by the execution of the program, a digital signal processor (DSP) 115 for performing digital processing and a block of analogue circuitry (ANLG) 116 for interfacing the DSP 115 to an analogue system (not shown) external of the ASIC 102. FIG. 1 shows approximately the silicon area taken up by each of these components and their physical positions relative to each other.

In this embodiment, the ASIC 101 constitutes a modem and allows a computer (not shown) to be connected via an RS232 serial data link to a telephone line (not shown). The ANLG block 116 interfaces the DSP 115 to the telephone line and the DSP 115 performs Viterbi decoding and tone generation/decoding. The DSP 115 also includes an RS232 interface to allow the ASIC 101 to be connected to the serial port of the computer. Thus the ASIC 101 provides a complete modem interface between an analogue telephone line and a computer.

FIG. 2a is a schematic block diagram illustrating the connection of the various blocks in the ASIC 101 and which shows the connection of the ASIC 101 through the DSP unit 115 to the RS232 interface of the computer and to the telephone line via the ANLG block 116. The processor 200 comprises the processor core 110, the MMU 111 and the SIF 112. In this embodiment, the processor core 110 has a Harvard architecture in which a separate program space bus (PMEM) 201 and a separate data space bus (DMEM) 202 are provided.

In general, processors have either a Harvard or a von Neuman architecture. In both architectures the processor sequentially fetches an instruction from a series of consecutive instructions and executes the fetched instruction. The processor continues to execute instructions from the consecutive series unless it is directed by a branch instruction to jump to a different series of consecutive instructions. Also in both architectures, an instruction may contain implicit data (also called an operand) and this implicit data may either be used immediately or it may be used to direct the processor to access a memory location specified by the implicit data. A processor with a Harvard architecture only fetches instructions from a program space and only accesses data (other than that implicit in an instruction) in a data space. In contrast, a processor with a von Neuman architecture has a unified space and the processor both fetches instructions and accesses data in this unified space. When a von Neuman processor fetches an instruction then the contents of the memory location being accessed are interpreted as an instruction whereas during a data access the memory location is interpreted as data.

As shown in FIG. 2a, the MMU 111 is connected between the processor core 110 and the program memory (ROM 113), the data memory (RAM 114), the DSP 115 and the ANLG block 116. FIG. 2a also shows the serial interface (SIF) 112 which allows an external device 299 to gain access to registers within the processor core 110 and to the program and data memory via an external interface group 211 of control signals.

FIG. 2b shows in more detail the main functional blocks of the processor 200. As shown, the PMEM bus 201 comprises a 24 bit address bus (PMEM_ADDR), a 16 bit data input bus (PMEM_DATA_IN) and two control signals (PMEM_ADDR_CHANGE and PMEM_WAIT) whose functionality is described later. The DMEM bus 202 comprises a 16 bit address bus (DMEM_ADDR), a 16 bit input data bus (DMEM_DATA_IN), a 16 bit output data bus (DMEM_DATA_OUT), a two bit control bus (DMEM_CNTRL) and a further control signal (DMEM_WAIT).

The PMEM bus 201 and DMEM bus 202 connect the processor core 110 to the MMU 111 and thus are wholly within the processor 200. Based on the PMEM bus 201 and the DMEM bus 202, the MMU 111 generates 2 further buses: a PBUS bus 203 and a DBUS bus 205, for interfacing the processor 200 with the other circuitry within the ASIC 101.

The PBUS bus 203 interfaces the processor 200 to the ROM 113 and comprises a 24 bit address bus (PBUS_ADDR), a 16 bit input data bus (PBUS_DATA_IN), a 16 bit output data bus (PBUS_DATA_OUT) and a 6 bit control bus (PBUS_CONTRL) which comprises 4 chip select lines, a read enable line and a write enable line.

The DBUS bus 205 comprises a 16 bit address bus (DBUS_ADDR), a 16 bit input data bus (DBUS_DATA IN), a 16 bit output data bus (DBUS_DATA_OUT) and a 6 bit control bus (DBUS_CONTRL) which comprises 4 chip select lines, a read enable line and a write enable line. The DBUS bus 205 connects the RAM 114 and the DSP 115 to the processor core 110 via the MMU 111.

As mentioned above, the SIF 112 provides a serial interface for the external device 299 to communicate with the ASIC 101. In this embodiment, the SIF 112 is similar to that described in WO 96/09583. The external device 299 may communicate (via the mediation of the MMU 111) with the processor core 110 or with the ROM 113 or RAM 114. When an external device 299 communicates with the processor 200 via the SIF 112, data may be transferred between the SIF 112 and the MMU 111 by a SIF bus 206. As shown, the SIF bus 206 comprises a 24 bit address bus (SIF_ADDR), a 16 bit input data bus (SIF_DATA_IN), a 16 bit output data bus (SIF_DATA_OUT), a 6 bit command group (SIF_CMND) and a control signal SIF_WAIT.

The SIF 112 also communicates directly with the processor core 110 via a 4 bit group CNTRL_SIF 209.

The processor core 110 receives a group of 2 control signals (CNTRL_EXT) 208 which allows circuitry external of the processor 200 to cause conditions such as interrupts. The processor 200 also receives a single clock signal (CLK), and is clocked on the rising edge of CLK.

The processor core 110 generates a group of 3 signals (CNTRL_OUT) 210 which provides the MMU 111, the SIF 112 and circuitry external of the processor 200 with an indication of the current state of the processor core 110. The CNTRL_OUT group 210 includes a signal SIF_OUT, the functionality of which is described later.

An arithmetic unit (AU) 250 is illustrated in FIG. 2b within the processor core 110. For the purposes of illustration, the AU 250 is shown with two input buses and an output bus.

The MMU 111 also comprises a Register bus 207 which allows the SIF 112 (on behalf of the external device 299) to gain access to registers within the processor core 110. The Register bus 207 comprises a 4 bit register address bus (REG_ADDR) and a 2 bit control bus of read and write enable signals (REG_CNTRL). A more detailed description of the functionality of the Register bus 207 is given later.

The signals that cross the boundary of the processor 200 may be considered to be the “pins” of the processor 200. However, the processor 200 is deeply embedded within the ASIC 101 and only four of the processor's pins are actually connected to bond pads 103 and hence taken outside the ASIC. These four signals are SIF_MOSI, SIF_CLK, SIF_LOADB and SIF_MISO which, as shown, together form the external interface group 211 which connects to the external device 299. All of the other bond pads 103 of the ASIC 101 are used for connecting the ANLG block 116 to the telephone line, the RS232 interface of the DSP 115 to the computer, and the ASIC 101 to a power supply. In this embodiment, none of the other processor 200 signals (PBUS bus 203, CNTRL_EXT 208 etc) are connected out to bond pads 103.

Programmer'S Model of the Processor

As the processor core 110 has a Harvard architecture, it loads and stores data in a data space 301 and it loads instructions (which may incorporate data) from a logically distinct program space 302. Each space consists of contiguous memory locations which can be uniquely addressed, although it is not essential that every potential memory location in a space is actually used.

FIG. 3a shows the arrangement of the program space 301 which comprises 16384 k (2²⁴) words of 16 bits and thus extends from address h000000 to hFFFFFF (where the prefix “h” is used to denote a hexadecimal number). After the application of power to the ASIC 101, the processor core 110 begins execution at address h000000; an interrupt causes the processor core 110 to jump to address h000004.

FIG. 3b shows the arrangement of the data space 302 which comprises 64 k (2¹⁶) words of 16 bits and thus extends from address h0000 to hFFFF.

FIG. 3c shows the logical arrangement of the registers within the processor core 110. The processor may be generally regarded as having a 16 bit architecture as most of the registers and most of the instructions operate on 16 bit values. Two general purpose 16 bit registers are provided (AH 311 and AL 310). For some instructions (for example n-bit shifting or multiplication), the AH and AL registers may be concatenated to form a 32 bit register, A, where AH forms the most significant word of A and AL forms the least significant word of A.

An 8 bit FLAGS register 319 contains 8 flags: T, B, I, U, C, S, N and Z. The C, S, N and Z flags are updated following the result of an arithmetic or test operation by the processor core 110 and, as those skilled in the art will appreciate, indicate carry, signed, negative and zero conditions, respectively. The T and B flags are used to control a software debugging mode which is described later. The T, B and U flags may be written to (writes to the other flags have no effect). The I flag is set by hardware interrupts.

The U flag selects whether the processor core 110 operates in an interrupt mode for performing interrupt handling or in a user mode. When the processor core 110 is the user mode it may be interrupted by either a hardware or a software interrupt. In either case, the interrupt clears the U flag (thus placing the processor core 110 in the interrupt mode) and also causes the processor core 110 to branch to program address h000004 where the ROM 113 contains an interrupt handling routine. When the processor core 110 is in the interrupt mode (i.e. the U flag is cleared) it will not respond to further interrupts until it returns to the user mode.

The processor core 110 also contains two sets of mutually exclusive index registers. One set (UX 312, UXH 313 and UY 314) is for use in the user mode and the other set (IX 315, 1×H 316 and IY 319) is for use in the interrupt mode. The index registers will hereafter generally be referred to as the X, XH, & Y registers as whether the user set or the interrupt set is used generally depends solely on the U flag. A specific reference to a user index register or an interrupt index register will only be made where there is a difference in behaviour between the two.

The X and Y registers are each 16 bits wide and are used by certain addressing modes as index registers. The XH register is 8 bits wide and is used in some addressing modes as a “page” register to select one of 256 (2⁸) pages, each page being 64 k words of the 16M word program space 301. Other addressing modes concatenate the X and XH registers to form a 24 bit index register.

The processor core 110 also contains a program counter register (PC 318) which is 24 bits wide and specifies the address of the current instruction being executed within the program space 301.

Instruction Set of the Processor

The processor core 110 fetches and executes 16 bit instruction words, one at a time, from the program space 301. All instructions share a common format.

As those familiar with the design or use of microprocessors will appreciate, the processor core 110 has a conventional instruction set comprising arithmetic instructions, logic manipulation instructions, load/store instructions and program flow control instructions. The processor core 110 also includes a SIF instruction, for controlling the SIF 112, which is described later.

Addressing Modes of the Processor

The processor core 110 has 4 addressing modes for accessing data from the data space 302 and 4 addressing modes for accessing instructions from the program space 301. The major difference between the data and the program space address modes is due to the fact that the data space 302 requires a 16 bit wide address whereas the program space 301 requires a 24 bit wide address.

The data space addressing modes include, as those skilled in the art will appreciate, immediate, direct and indexed addressing modes.

The program flow control (branch) instructions use the program addressing modes to alter the flow of a program if the conditions (if any) required to take the branch are satisfied. The program addressing modes include relative, direct and indexed addressing modes.

Architecture of the Processor

As mentioned above, the processor 200 fetches and executes instructions from the program space 301 one at a time. The main architecture of the processor core 110 which performs the fetching of the appropriate instruction and which carries out the operation of the instruction will now be described.

The processor core 110 is designed to execute most instructions in a single cycle of the system clock CLK. Some operations, such as multiplication and divide and indexed program 301 or data space 302 memory accesses, take several extra CLK cycles. In order to allow for slow memory on the PMEM bus 201 or the DMEM bus 202 (and via the MMU 111, on the PBUS bus 203, the SHARED bus 204 or the DBUS bus 205) the processor core 110 may be paused by the assertion of PMEM_WAIT or DMEM_WAIT (shown in FIG. 2b). Their assertion causes the processor core 110 to insert wait states until the memory being accessed is ready.

Instruction words from the ROM 113 are read in on the PMEM_DATA_IN bus and are latched into a 16 bit instruction register (not shown). Each instruction word comprises an opcode specifying an instruction to be executed. On the receipt of an opcode, an instruction decode and control unit (not shown) decodes the opcode and enables and sequences the appropriate parts of the processor core 110 in order to effect execution of the instruction.

Reads from the program space 301 and the data space 302 are controlled by a memory read unit (not shown) which performs the appropriate memory accesses (for example to fetch a data value from the data space 302 as part of a memory access in the direct data addressing mode) and also inserts wait states, if required, until the read has been completed. Loads and stores to and from the registers are controlled by a load/store unit (not shown) which selects the appropriate register and updates the N and Z flags after a load or store operation. The load/store unit operates in conjunction with the memory read unit during loads and during direct and indexed addressing mode stores.

The AU 250 is designed as an independent unit, with a well defined interface to the processor core 110. This allows for future upgrading of the AU 250 for performance, power or functional reasons without requiring modification to the remainder of the processor core 110. Logic (such as exclusive or) and n-bit shift operations are also performed by the arithmetic unit 250.

PMEM_WAIT and DMEM_WAIT cause the processor core 110 to insert wait states into the current program 301 or data space 302 access (or into both if they are being accessed simultaneously) until the respective signal is de-asserted.

The processor core 110 executes one instruction after another. The program stored in the program space 301 is arranged so that, usually, the next instruction that will be executed is at the consecutively next address (i.e. at PC+1). Therefore, in this embodiment, during the execution of the current instruction, the processor core 110 automatically fetches the next instruction which it loads onto the PMEM_DATA_IN bus. This instruction waits on this bus until loaded into the instruction register. However, as those skilled in the art will appreciate, if the current instruction is a branch instruction, then the instruction from PC+1 which is waiting on the PMEM_DATA_IN bus may not in fact be the next instruction to be executed. When this happens, the processor control block 4201 asserts the control signal PMEM_ADDR_CHANGE to indicate to the MMU 111 that the address on the PMEM bus 201 has been changed by the branch instruction and that the MMU 111 should read the instruction word from the ROM 113 at the address now specified on the PMEM bus 201.

DMEM_READ and DMEM_WRITE, of the DMEM_CNTRL bus, are strobes to indicate that a read or write access, respectively, is to be made to the data space 302 at the address indicated by the DMEM bus 202.

Extended Program Space

AS will be apparent to those skilled in the art, the data processing portion of the processor core is effectively a 16 bit core that has been extended to access a 24 bit program space 301. Compared to a 16 bit program space, the program space 301 allows larger and more complicated software programs to be incorporated into the ASIC 101. This extension is achieved by concatenating a 16 bit value from a register with an 8 bit operand from an instruction to specify an address within the 24 bit program space 301.

Serial Interface (SIF)

A SIF instruction causes the processor core 110 to assert the SIF_OUT signal (part of the CNTRL_OUT group 210) and, if a SIF command has been loaded by the external device 299 into the SIF 112, causes that SIF command to be processed by the SIF 112. (A SIF command may, for example, write to a register of the processor core 112 or read a memory location in the program space 301 or data space 302). A loaded SIF command remains pending until activated by a SIF instruction. If there is no SIF command pending at the time of a SIF instruction then the SIF instruction executes as a no-operation instruction. The SIF 112 uses a shift register (not shown) to transfer data with the external device 299 via the external interface group 211.

Some of the 6 signals of the SIF_CMND group of the SIF bus 206 discussed above are TWOWB, DEBUG, PDB, SIF_READ and SIF_WRITE, and are used to indicate to the MMU 111 the nature of the current SIF data transfer with the external device 299. TWOWB is asserted by the SIF 112 to indicate whether a two word (32 bit) or a one word (16 bit) SIF command access is taking place. In a two word access, two consecutive 16 bit words in the data space 302 or in the program space 301 are accessed. DEBUG is asserted to indicate that the SIF access is to a register within the processor core 110 (and not to either the program space 301 or the data space 302). PDB, when DEBUG is de-asserted, is used to indicate whether the SIF access is to the program space 301 or to the data space 302. SIF_READ and SIF_WRITE are asserted to indicate whether the SIF 112 is reading or writing, respectively, data from or to the processor core 110.

After a SIF command has been loaded by the external device 299 into the SIF 112, the SIF 112 asserts a signal SIF_PENDING (which is the sixth signal of the SIF_CMND group of the SIF bus 206) and this signal indicates to the MMU 111 that a SIF command is pending. The MMU 111, in turn, asserts the signal SIF_WAIT to indicate to the SIF 112 that the requested data transfer (with the program/data space 301/302, or a register, on behalf of the external device 299) has not been completed. The SIF command will remain pending until the processor core 110 executes a SIF instruction. Once the data transfer (which may include wait states if the MMU has to access slow memory) has been completed, the MMU 111 de-asserts SIF_WAIT to indicate that the requested read or write has been completed and in response to this de-assertion, the SIF 112 indicates to the external device 299 that the data transfer (read or write) has been completed.

The SIF 112 indicates the address of the data transfer to the MMU 111 using the SIF_ADDR bus of the SIF bus 206. All 24 bits of the bus are used to specify an addresses in the program space 301, 16 bits are used to specify an address in the data space 302 while 4 bits are used to specify a register (the type of transfer depends on the SIF command received from the external device 299).

During writes by the SIF 112, data to be written to a register or to memory is placed onto the SIF_DATA_OUT bus of the SIF bus 206. During reads by the SIF 112, data is read from a register or memory location on the 16 bit bus SIF_DATA_IN (part of the SIF bus 206) from the MMU 111 for the transfer to the external device 299.

Alternative Architectures

In the processor architecture described above, the program space 301 and the data space 302 were provided in separate memory devices (ROM 113 and RAM 114 respectively). The memory management unit 111 can be configured to connect the processor core to the program space 301 and the data space 302 in a number of different configurations, including a configuration in which part or all of the program space 301 and the data space 302 are provided in a single memory device using a shared data bus.

FIGS. 4a to 4d show four examples illustrating different ways that the MMU 111 can be configured to connect the processor core 110 to the memory. As will be described later, one of these configurations is chosen at compile time of the processor and once compiled the MMU 111 will interface the processor core 110 to the memory using the chosen configuration.

FIG. 4a shows an ASIC 801 which is similar to the ASIC 101. However, the ASIC 801 also comprises a data ROM 811 which stores several sets of coefficients for use by the DSP 115. The processor core 110 reads the appropriate set of coefficients from the data ROM 811 and loads these coefficients into the DSP 115. For example, different sets of coefficients may be provided for interfacing the ASIC 801 to different telephone lines in different regions of the world. Also shown is an analogue functional block 810 which the processor core 110 may (via the MMU 111) directly read and write to/from in order to determine the state of the telephone line such as whether it is on or off-hook. The program ROM 113 is connected to the MMU 111 by the PBUS bus 203 whilst the RAM 114, DSP 115, ANLG 810 and data ROM 811 are connected to the MMU 111 by the DBUS bus 205.

FIG. 4b shows an ASIC 802 similar to the ASIC 801 but where the program ROM 113 and the data ROM 811 are replaced by, and combined within, a shared ROM 812 which connects to the MMU 111 via a SHARED bus 850.

The SHARED bus 850 is similar to the PBUS bus 205 and comprises a 24 bit address bus (SHARED_ADDR), a 16 bit input data bus (SHARED_DATA_IN), a 16 bit output data bus (SHARED_DATA_OUT) and a 6 bit control bus (SHARED_CONTRL) which comprises 4 chip select lines, a read enable line and a write enable line. Whereas the PBUS bus 203 and the DEBUS bus 205 are dedicated to the program space 301 and data space 302, respectively, the SHARED bus 850 may be used for both program space 301 and data space 302 memory accesses (though not simultaneously).

The advantage of using a shared ROM 812 is that such a ROM often requires a smaller area on an ASIC than the use of two separate ROMs. The RAM 114, DSP 115 and ANLG 810 are connected to the DBUS bus 205 as for the ASIC 801. The MMU 111 ensures that accesses to program space 301 access the program portion of the shared ROM 812 whilst accesses to data space 302 access the data coefficient portion of the shared ROM 812.

FIG. 4c shows an ASIC 803 similar to that of the ASIC 802 except that the shared ROM 812 is not integrated into the ASIC 803 but is an off-chip external device. An example of a situation where the configuration shown in FIG. 4c would be desirable is where the program contained in the shared ROM 812 is so large that it is more economic to purchase and program a standard ROM device than to integrate the shared ROM 812 into the ASIC 803.

FIG. 4d shows an ASIC 804 similar to the ASIC 802 but wherein the ANLG block 810 is external to the ASIC 804 and wherein the program is also stored on an additional ROM 820. The additional ROM 820 is an off-chip external device and connects to the MMU 111 via the PBUS bus 203. An example of an application where the configuration of FIG. 4d would be used is where a family of similar products incorporating the processor core 110 all use a common program with common data co-efficients which are loaded into the ROM 812 and which each have a different additional program for performing different additional tasks, which is stored in the external ROM 820.

Memory Management Unit (MMU)—Configuration

As will be apparent from the above alternatives, the MMU 111 provides a simple, flexible and powerful interface for interfacing the processor core 110 to devices external of the processor 200 (e.g. the RAM, ROM, DSP and devices external to the ASIC). Since the access to these external devices may take some time, the MMU 111 is also configured to automatically insert the appropriate number of wait states when accessing these devices. The MMU 111 also directs accesses on the PMEM bus 201 and the DMEM bus 202 to the appropriate bus connected to the external device (either to the PBUS bus 203, the SHARED bus 850 or the DBUS bus 205). The MMU 111 also provides an interface between the SIF 112 and the processor core 110 and the ROM 113 and RAM 114. The MMU also includes chip select generation logic to provide chip select signals to devices or systems connected to the processor 200.

As mentioned above, the configuration of the MMU 111 is determined at compile time. In this embodiment, the designer of the processor defines the desired MMU configuration in an MMU configuration file. Table 1 shows an example of the MMU configuration file for a memory configuration similar to that shown in FIG. 4d (where the prefix “h” defines a hexadecimal number, the prefix “b” defines a binary number and where “X” stands for a “don't care” binary level).

TABLE 1
EXAMPLE MMU 111 CONFIGURATION FILE

| | | |
|---|---|---|
| // Configurable MMU | | |
| // | | |
| // Definitions File | | |
| parameter PROGBANK0 | = | 24′b0000,0000,XXXX,XXXX,XXXX,XXXX |
| parameter PROGBANK1 | = | 24′b0001,XXXX,XXXX,XXXX,XXXX,XXXX |
| parameter PROGBANK2 | = | 24′b10XX,XXXX,XXXX,XXXX,XXXX,XXXX |
| parameter PROGBANK3 | = | 24′b11XX,XXXX,XXXX,XXXX,XXXX,XXXX |
| parameter DATABANK0 | = | 16′b1111,1XXX,XXXX,XXXX |
| parameter DATABANK1 | = | 16′b0XXX,XXXX,XXXX,XXXX |
| parameter DATABANK2 | = | 16′b1000,00XX,XXXX,XXXX |
| parameter DATABANK3 | = | 16′b1010,0000,0000,XXXX |
| parameter PROG0WAIT | = | X |
| parameter PROG1WAIT | = | 3 |
| parameter PROG2WAIT | = | 0 |
| parameter PROG3WAIT | = | 0 |
| parameter DATA0WAIT | = | X |
| parameter DATA1WAIT | = | 1 |
| parameter DATA2WAIT | = | 4 |
| parameter DATA3WAIT | = | 7 |
| parameter SHARED0WAIT | = | 1 |
| parameter SHARED1WAIT | = | X |
| parameter SHARED2WAIT | = | X |
| parameter SHARED3WAIT | = | X |
| parameter PROG0TYPE | = | Shared |
| parameter PROG1TYPE | = | Separate |
| parameter PROG2TYPE | = | Separate |
| parameter PROG3TYPE | = | Separate |
| parameter DATA0TYPE | = | Shared |
| parameter DATA1TYPE | = | Separate |
| parameter DATA2TYPE | = | Separate |
| parameter DATA3TYPE | = | Separate |
| parameter DATA0OFFSET | = | 8′h01 |
| parameter DATA1OFFSET | = | 8′b0000,0000 |
| parameter DATA2OFFSET | = | 8′b0000,0000 |
| parameter DATA3OFFSET | = | 8′b0000,0000 |

As can be seen from Table 1, the MMU configuration file has 8 main parts. The first and second parts are used to divide the program space 301 and the data space 302 into a number of memory banks (in this embodiment up to a maximum of four memory banks). The banks may be of any size subject to the proviso that the number of data words in each bank must be an integer power of 2, and that none of the four memory banks within the program space 301, or the four memory banks within the data space 302, may overlap. In the example of Table 1, the shared ROM 812 has 128 k words and forms bank 0 of the program space 301, from address h000000 to h01FFFF, whilst the uppermost 1 k of the shared ROM 812 also forms bank 0 of the data space 302. The additional ROM 820 has 1M words and forms bank 1 of the program space 301, from h100000 to h1FFFFF. The RAM 114 forms bank 1 of the data space 302 from h0000 to h7FFF. The DSP 115 forms bank 2 of the data space 302, from h8000 to h83FF, whilst the ANLG block 810 forms bank 3 and extends from hA000 to hA00F.

Each memory bank is assigned a predetermined number of wait states which depend on the time required to access the memory bank. These wait states are defined in the third, fourth and fifth parts of the configuration file by the parameters PROGxWAIT, DATAxWAIT and SHAREDxWAIT. These wait states will be inserted on the appropriate wait input (i.e. DMEM_WAIT or PMEM_WAIT) to the processor core 110 every time an access is made to that memory bank. Wait states are also inserted on SIF_WAIT if the SIF 112 is accessing one of the memory banks.

The sixth and seventh parts of the configuration file are used to specify, for each memory bank, whether it is to be in a separate memory device or whether it is to be in a shared memory device. In the example of Table 7, memory bank 0 of the program space 301 and bank 0 of the data space 302 are shared (within the shared ROM 812). Memory accesses in the program space 301 in the range h000000 to h01FFFF address all 128 k words of the shared ROM 812 (although only the first 127 k are actually used by the program); memory accesses in the data space 302 in the range hFC00 to hFFFF address the uppermost 1 k of the shared ROM 812.

In this embodiment, addresses in the 1 k of data space 302 are addressed by a 16 bit address mode. If the data space 302 and the program space 301 are provided in a single memory device and the shared bus is used to access both data space 302 and program space 301, then the 16 bit address of the data space must be extended to 24 bits to match the width of the address bus of the shared bus 204. The appropriate extension is specified in the eighth part of the configuration file and defines the physical location of the data space 302 in the shared memory. In the illustrated example, for the data bank 0, the offset is specified as h01. Therefore, memory accesses in the range hFC00 to hFFFF of the data space 302 appear on the shared bus 204 as addresses in the range h01FC00 to h01FFFF.

In addition, each memory bank has an active high chip select line which is used to enable the output buffers within the selected memory device, or to assist in address decoding. The chip select signals form part of the PBUS_CNTRL and DBUS_CNTRL groups, respectively, shown in FIG. 2b. Memory banks may be specified as accessing the SHARED bus 850 in which case the corresponding data and/or program space chip selects are diverted to the SHARED_CNTRL group. Whatever configuration is adopted, the maximum number of chip select signals available, in this embodiment, is eight.

Memory Management Unit (MMU)—Circuitry

The circuitry available in the MMU 111 will now be described with reference to FIGS. 5a and 5b. As was described above, the memory management unit 111 can connect the processor core 110 in various ways to a number of memory devices. The entire circuitry that may be available in the MMU 111 will therefore be described. However, as those skilled in the art will appreciate, the actual circuitry used in the MMU 111 may be a lot simpler since some of the circuitry may not be used. Any such simplification of the MMU circuitry is made at compile time by a computer-aided design tool, such as that available from Synopsis Inc known as “Design Compiler”, which automatically generates the MMU circuitry from the MMU configuration file.

FIG. 5a shows a data path portion 9100 of the MMU 111. Four multiplexers, 9101 to 9104, are used to route data from its source to its appropriate destination. As shown, PMEM_DATA_IN is connected, via a dual input multiplexer 9101, to either PBUS_DATA IN or to SHARED_DATA_IN, as the program space 301 may be physically located on either (or both) the PBUS bus 203 or the SHARED bus 850. (Note that in the MMU 111 used in the ASIC 101 shown in FIG. 1, the multiplexer 9101 is not necessary, since the SHARED bus 850 is not used.) Although the processor core 110 cannot write to the program space 301, the SIF 112 can write to the program space 301 (provided that the memory device supports writes) and so SIF_DATA_OUT is routed to PBUS_DATA_OUT. DMEM_DATA IN is connected, via a triple input multiplexer 9102, to either SHARED_DATA_IN, DBUS_DATA_IN or SIF_DATA OUT.

DBUS_DATA_OUT and SHARED_DATA_OUT are both driven by the output of a dual input multiplexer 9103 which connects them to either DMEM_DATA_OUT or SIF_DATA_OUT. There are no circumstances in which different data would be written simultaneously to both the SHARED bus 850 and the DBUS bus 205 and therefore the data output portions of these two buses share the multiplexer 9103. A quad input multiplexer 9104 connects SIF_DATA_IN to either PBUS_DATA_IN, SHARED_DATA_IN, DBUS_DATA_IN or DMEM_DATA_OUT.

FIG. 5b shows a block diagram of the MMU control and address logic 9200 of the MMU 111.

REG_ADDR is formed from the four least significant bits of SIF_ADDR and forms part of the Register bus 207. The Register bus 207 is used by the SIF 112 to specify a register in the processor core 110 from/to which data is to be read or written during a SIF command.

A dual input 24 bit multiplexer 9201 selects between PMEM_ADDR and SIF_ADDR to drive the address on the program space address bus PBUS_ADDR. Normally, PMEM_ADDR is selected, unless the SIF 112 is reading or writing to the program space 301. A corresponding dual input 16 bit multiplexer 9202 selects between the 16 least significant bits of SIF_ADDR and DMEM_ADDR to drive the address on the data space address bus DBUS_ADDR. The multiplexer 9202 normally selects DMEM_ADDR unless the SIF 112 is reading or writing to the data space 302. PBUS_ADDR and DBUS_ADDR both feed a dual input 24 bit multiplexer 9203 which drives the SHARED_ADDR bus used to access a common memory device. As shown in FIG. 5b, the 16 bit data address is extended to 24 bits by a data memory shared mapping unit 9209. The way in which this mapping is achieved is discussed later.

A PMEM bank block 9204 takes its input from the PBUS_ADDR bus and decodes the address to form up to four chip select signals (CS_PBANK), one for each bank of the program space 301 which form part of the PBUS_CTRL signals. A corresponding DMEM bank block 9205 decodes addresses on the DBUS_ADDR bus to form four chip selects (CS_DBANK), one for each bank of the data space 302 which form part of the DBUS_CTRL signals. When a bank in the program space 301 and/or data space 302 is designated as a shared bank, then the respective program and/or data chip select signal is diverted to the SHARED_CNTRL group of the SHARED bus 850.

The chip select signals output from the bank blocks 9204 and 9205 are also input to a bus arbitration block 9206. which arbitrates between accesses to the program space 301 and to the data space 302 made by the processor core 110 and accesses made by the SIF 112. Thus the bus arbitration block 9206 controls the multiplexers 9101, 9102 and 9103 (shown in FIG. 5a) and multiplexers 9204, 9201, 9202 and 9203 (shown in FIG. 5b). The bus arbitration block 9206 also takes as inputs the signals PMEM_ADDR_CHANGE (which indicates that the processor core 110 requires an instruction to be fetched from the program space 301), all six signals of the SIF_CMND group of the SIF bus 206 (which indicate, amongst other things, that a SIF command is pending), SIF_OUT (part of the CNTRL_OUT group 210, which indicates that the processor core 110 is executing a SIF instruction) and the DMEM_CNTRL group (part of the DMEM bus 202, which indicates that the processor core 110 requires a read or a write to the data space 302).

One of the functions performed by the bus arbitration block 9206 is that of ensuring that partially completed bus accesses are completed before allowing a new access on the same bus to commence. This is particularly important in embodiments where both program space 301 and data space 302 accesses may be performed on the SHARED bus 850, or in the situation when the SIF 112 attempts to access the program 301 or data space 302 before the processor core 110 has completed an access. Thus the bus arbitration block 9206 produces three signals, PMEM_WAIT, DMEM_WAIT and SIF_WAIT, to insert wait states into an attempted bus access that would otherwise cause a conflict with a partially completed bus access. The bus arbitration block 9206 employs two counters, a program wait counter 9207 and a data wait counter 9208, to count the appropriate number of wait state cycles to be inserted into a respective program space 301 or data space 302 bus access.

As an example, if the SIF 112 is reading data from the data portion of the shared ROM 812 on the SHARED bus 850 and then if the processor core 110 attempts to fetch an instruction from the program portion of the shared ROM 812, the PMEM_WAIT signal would be asserted. On the other hand, if, during a similar SIF access, the processor core 110 attempted to fetch an instruction from the additional ROM 820 on the PBUS bus 203 then PMEM_WAIT would not be asserted (other than as required to insert any wait states to allow for slow memory) as there would be no conflict between simultaneous accesses by the processor core 110 and the SIF 112 on these two buses.

As mentioned above, when part or all of the program space 301 is shared with part or all of the data space 302, the 16 bit data address is extended to 24 bits by the DMEM shared mapping block 9209. Four different 8 bit extensions may be provided (one for each bank of the data space), as defined by the MMU configuration file. In Table 1 only data memory bank 0 is specified as being shared and therefore a valid extension is only generated for data space 302 accesses that lie in memory bank 0. The extension is specified by the parameter DATA0OFFSET and in this example is h01 so that a data space 302 address of hXXXX is mapped to address h01XXXX on the SHARED bus 204. In this embodiment, the DMEM mapping block 9209 receives the four chip select signals output from the DMEM bank block 9205. When the DMEM mapping block 9209 detects that the chip select signal for a data bank which is to be shared is asserted, it generates the appropriate 8 bit extension which it outputs to the multiplexer 9203 on the most significant 8 bits.

The MMU 111 also has circuitry (not shown) which allows for the generation of a 10 bit extension for one or more shared data memory banks. The two additional extension bits are used to replace the two most significant bits of the DBUS_ADDR bus. As a result, the size of the shared data memory bank cannot be larger than 16 k. However, with the additional two bits of the extension, this 16 k memory bank can be mapped to one of 1024 locations (as compared to one of 256 locations using the 8 bit extension).

ASIC Design Process

As has been explained, many different configurations of the MMU 111 are possible depending upon the particular parameters of the MMU configuration file. With conventional memory interface support circuitry, such as that provided in the Intel 80186 processor, it is necessary for the processor to configure the memory interface support circuitry by writing appropriate values to registers within this support circuitry.

In contrast, the MMU 111 is a particular embodiment of what may be regarded as a generic MMU. The generic MMU is a behavioural description written in, for example, the Verilog hardware description language which embodies a parameterised description of all the potential configurations that the generic MMU may adopt. The designer of an ASIC specifies the required configuration of the generic MMU by specifying appropriate values of the parameters in the MMU configuration file for the ASIC. These parameters describe a particular configuration and therefore a particular behaviour of the generic MMU. Once the behaviour of the particular MMU has been specified then digital circuitry to embody the specified behaviour is synthesised. The synthesis process is discussed later in more detail. Verilog is a standard language as defined by the Institute of Electrical and Electronic Engineers (IEEE) as standard number 1364. An alternative hardware description language that may be used, instead of Verilog, is VHDL which is IEEE standard number 1076.

The use of an MMU configuration file in conjunction with a generic MMU confers several advantages over the use of conventional memory interface support circuitry:
i) lack of programming,
ii) reduced silicon area, and
iii) performance.

The MMU 111 that is embodied on the ASIC 101 has fixed circuitry, tailored to the design of the ASIC, and therefore the processor core 110 does not need to load configuration data into the MMU 111 (like the prior art processors). As the MMU 111 does not require configuration, the processor core 110 may, after being reset, directly execute program instructions related to the functionality of the system in which the ASIC is embodied, rather than first spending time attending to initialisation (as would be required with conventional memory interface support circuitry).

Further, since conventional memory interface support circuitry is programmable it necessarily comprises circuitry that is superfluous to a particular configuration. Such superfluous circuitry would, however, occupy area on an ASIC and as the cost of an ASIC is roughly proportional to its area, this represents an unnecessarily increased cost.

The configuration of the MMU 111 is determined during the design and the synthesis of the ASIC 101 whereas the configuration of conventional memory interface support circuitry is established during initialisation by the processor. Thus the digital circuitry of the MMU 111 can be optimised (with regard to both speed and silicon area) for a particular system. This reduces the manufacturing cost of the ASIC 101 and allows it to have a higher performance.

FIG. 6 is a block diagram illustrating an example of a design process 1000 which may be used to manufacture the ASIC 101. Initially, a synthesis step 1001 takes three inputs, a processor file 1200, an MMU configuration file 1111c and a DSP description file 1115 and synthesises the logic of the ASIC 101 according to the contents of these files. The processor file 1200 contains a CPU portion 1110 which is a behavioural description of the processor core 110, an MMU portion 1111 which is a generic description of the MMU 111 and a SIF portion 1112 which is a description of the behaviour of the SIF 112. The MMU configuration file 1111c (see Table 1) contains parameters which, in conjunction with the MMU portion 1111, specify the particular behaviour required of the MMU 111. The DSP description file 1115 specifies the behaviour of the DSP 115. The files 1200, 1111c and 1115 specify all the logic of the ASIC 101 except for the ROM 113 and the RAM 114.

The synthesis step 1001 generates a register transfer level (RTL) description of the logic of the ASIC 101 as specified by the files 1200, 1111C and 1115. As an example, the shift register of the SIF 112 is generated by the concatenation of one bit shift register primitives. As those skilled in the art will appreciate, multi-bit adders and multiplexers may also be formed from smaller primitives.

The RTL description output by the synthesis step 1001 is used by a fitting step 1002 which “fits” this description to the chosen technology of the ASIC 101. As those skilled in the art will appreciate, ASICs are conventionally either “sea of gates” or cell based. To fit the RTL description to a sea of gates ASIC the RTL description must be decomposed into, for example, 2 input NAND gates. Thus, for example, a 3 input NAND gate would be formed from a combination of 2 input NAND gates. A cell based ASIC provides functions such as registers and small macro-logic functions. For example, a cell may comprise a D type flip-flop and a four bit look-up table. Thus a four input NAND gate could be directly implemented in a cell using a look-up table whereas a 5 input NAND gate would require two look-up tables to be concatenated and hence would require two cells.

The synthesis 1001 and fitting 1002 steps will typically also provide for the optimisation of the logic that is to be embodied in the ASIC 101. For example, address generation circuitry (not shown) used by the processor core 110 may comprise four adders and a multiplexer. For a sea of gates ASIC that is to be optimised for silicon area usage, the four adders and multiplexer would typically be replaced with a combination comprising four multiplexers and a single adder (since that combination is functionally equivalent yet requires fewer logic gates).

The synthesis step 1001 also removes logic that is not required by a particular configuration of the MMU 111. For example, in the ASIC 101 there are no memory devices connected to the SHARED bus 850 and therefore, the multiplexer 9203 is superfluous and can be removed. As those skilled in the art will appreciate, logic can in general be removed, or simplified, whenever an output signal is not connected or whenever an input signal is permanently at either logic “0” or logic “1”.

The synthesis step 1001 and the fitting step 1002 may also, or instead, be used to synthesise and fit the three files 1200, 1111c, 1115 to a Field Programmable Gate Array (FPGA) 1003. A programmed FPGA may be regarded as a special case of an ASIC and in some circumstances may be preferable to a (custom-manufactured) ASIC. For example, use of FPGAs may be preferable where time-to-market considerations are critical or where it is known that the evolution of standards could require modification to, for example, the DSP 115 (e.g. in order to accommodate revised modem standards). FPGAs typically have a different structure from ASICs and therefore the fitting step 1002 would have to be modified in order to fit the three files 1200, 1111c, 1115 to the FPGA 1003. A placement step (not shown) must also be performed to fit the output of the fitting step 1002 to the FPGA 1003.

A simulation step 1004 is then performed. The simulation step 1004 allows the design of the DSP 115 to be checked and also allows the interaction between the DSP 115 and the processor 200 to be checked. The simulation step 1004 also allows application software 1005 to be simulated. The application software 1005 is the program intended for the ROM 113 and this level of simulation allows the application software 1005 to be simulated before the design is manufactured as an ASIC.

A placement step 1006 determines optimum or near optimum locations for the various elements of the ASIC 101. For example, the SIF shift register will typically comprise a plurality of elements (e.g. D type 1 bit registers) and it will generally be desirable that these elements are all relatively close to each other on the ASIC 101. The placement step 1006 places the output file produced by the fitting step 1002 and thus determines optimum relative positions and interconnectivity for the gates or cells. The placement step 1006 also takes three other files as inputs: a ANLG macro file 1116, a RAM macro file 1114 and a ROM macro file 1113. The ANLG macro file 1116 specifies the layout and placement of the analogue circuitry of the ANLG block 116, the RAM macro 1114 specifies the layout and placement of the circuitry of the RAM 114 and the ROM macro 1113 specifies the layout and placement of the circuitry of the ROM 113. The files 1116, 1114 and 1113 may either contain ready simulated placed and routed macros or may contain descriptions of their blocks at the transistor level (in which case these blocks would also require placing and routing by the placement step 1006).

After the placement step 1006 it is usual to “back annotate” simulation files produced by the simulation step 1004 as this back annotation allows, for example, the substitution of nominal delays with the actual propagation delays likely to be encountered by the placed ASIC. For example, a placed circuit path may have a length of 1 mm, and may incur a predicted propagation delay of 1 nanosecond. For optimum accuracy, these delays are incorporated into the simulation step 1004 and the design is re-simulated to ensure that the placed design meets the required design rules and tolerance margins.

At step 1007 masks are produced from the output of the placement step 1006 for lithography onto a silicon wafer. At step 1008 these masks are used to fabricate a wafer having a plurality of ASIC dice. At step 1009 the dice are tested whilst still on the wafer. At step 1010 the dice are separated and the dice that have passed the tests of step 1009 are packaged. An example of a suitable package is the industry standard 14 pin dual-in-line package on 0.1 inch centres. As part of the packaging step 1010 the bond pads are connected to their respective leads of the package, resulting in a finished ASIC 101.

Steps 1001 to 1004 are performed automatically by Computer Aided Design (CAD) software and Computer Aided Engineering (CAE) software which processes the files 1200, 1111c and 1115. The designer of the ASIC 101 only specifies the files 1111c and 1115 as the processor file 1200 will not normally require modification. At step 1004 the designer of the ASIC 101 checks the simulation results and if these do not meet the design criteria then the designer repeats steps 1001 and 1002 using different settings. For example, if the circuitry does not operate fast enough then the designer may instruct steps 1001 and 1002 to use different optimisation settings, for example to prioritise higher speed over reduced area. The placement step 1006 is performed automatically by more CAE software. If the software cannot automatically produce a placed design then the designer may assist the CAE software by providing “seed” information to guide the initial placement of the various functional elements of the ASIC 101. Back annotation and another round of simulation at step 1004 is performed automatically by the CAE software once the design has been placed.

The masks at step 1007 are produced by the CAE software plotting the placed information to form patterns which are then photographically reduced to form the masks which are used at step 1008 for photolithography in a conventional photolithography machine. Conventional processing machines (such as diffusers and ion beam implanters) may be used at step 1008. At step 1009 a conventional wafer-testing machine for testing wafer-mounted devices is used. Such a machine typically connects directly to the bond pads of a die on a wafer. The wafer is then sawn into individual dice and any faulty dice are discarded. Finally, step 1010 is performed by a conventional packaging machine which attaches bond wires to the bond pads 103. The packaging machine also encapsulates each die by injection moulding epoxy resin around each die.

Further Notes and Alternative Embodiments

Those skilled in the art will recognise that the detailed implementation of the microprocessor or other circuit embodying any aspect of this invention need not be limited to the examples given above. For example, the instruction set can be changed to suit a given application as can the widths of address and data buses. Even at a more general level, the scope of the present invention encompasses many individual functional features and many sub-combinations of those functional features, in addition to the complete combination of features provided in the specific embodiment. Whether a given functional feature or sub-combination is applicable in a processor having a different architecture, for example a processor with pipelined instruction decoding and execution, will be readily determined by the person skilled in the art, who will also be able to determine the adaptations or constraints imposed by the changed architecture.

Although the processor 200 has been described in terms of an ASIC embodiment, it is also envisaged that a stand-alone version of the processor could instead be produced. Such a stand alone processor would incorporate the SIF 112 and could have the MMU 111 configured to provide either a Harvard interface or a von Neuman interface to external devices.

Furthermore, although the processor 200 has been described as comprising a processor core 110 (in turn comprising an AU 250, an MMU 111 and a SIF 112), these four components need not be integrated onto the same piece of silicon. For example, the processor core 110 and the AU 250 could be formed on one silicon die whilst the MMU 111 and the SIF 112 could be formed on a different silicon die (with the connections between these dice being made via the bond pads 103 on each of the dice). Similarly, if the processor is formed by programming an FPGA then in some circumstances it may be necessary to partition the logic amongst a plurality of FPGAS. This is particularly likely to be the case if relatively simple devices such as programmable logic devices (PLDS) are used to embody the processor.

In other embodiments, the SIF 112 may be omitted from the processor 200 (with suitable modification to the interface between the MMU 111 and the processor core 110).

In an alternative embodiment of the processor core 110, the AU 250 is omitted. This would reduce the amount of logic required to implement the processor core 110; arithmetic operations could still be performed by using logical operations such as AND and OR, in conjunction with the shift logic of the AU 250.

All or part of the program store may in some cases need to be off-chip. If the pin count associated with off-chip storage is too high, it may be reduced for example by providing an 8 bit program ROM, and performing multiple accesses to build up each instruction word.

Steps 1001 to 1006 were described as being performed by software running on a computer. Such software is typically supplied on a CD-ROM or on floppy disks, or may be downloaded from the internet. Instead of receiving the three files 1200, 1111c, 1115, the software may be arranged to instead receive a single file. This single file may contain pointers to other files stored on the computer on which the software is running, or on the internet, and then the software would then automatically load in any files pointed to by the single file.

An earlier method described the manufacture of the ASIC 101 using a mask at step 1008 for photolithography. Alternative methods may, for example, use soft x-rays in order to obtain increased resolution when exposing a wafer. Instead of using a mask, an alternative method uses an electron beam which is steered over the surface of the wafer to form exposed regions in accordance with the placed design of step 1006.

Although the processor 200 has hitherto been discussed in terms of binary logic, alternative embodiments may use multi-level logic or may use quantum effect devices, as appropriate.

1. A computer based method of designing a processor for use in an integrated circuit, wherein the processor comprises a processor core for executing a program comprising a sequence of program instructions selected from a predetermined instruction set, and a memory management unit for interfacing the processor core with one or more memory devices, the method comprising:
receiving first data defining a logic arrangement of the processor core;
receiving second data defining a generic logic arrangement of the memory management unit, wherein the generic logic arrangement comprises logic defining a Harvard interface, having separate buses for performing instruction memory accesses and data memory accesses, between the processor core and one or more memory devices and logic defining a von Neuman interface, having a common bus for performing instruction memory accesses and data memory accesses, between the processor core and one or more memory devices;
receiving a user specification of a Harvard interface or a von Neuman interface for the memory management unit for the or each memory device; and
processing the second data in accordance with the received user specification to generate third data defining a logic arrangement of the memory management unit in accordance with the user specification.

2. A method according to claim 1, wherein the step of receiving the first data comprises receiving data defining a processor core having a Harvard architecture.

3. A method according to claim 1, further comprising the step of processing the first data and the third data to generate fourth data defining a physical arrangement of the processor.

4. A method according to claim 3, further comprising the step of manufacturing a mask from the fourth data for use in exposing a semiconductor wafer to radiation during the manufacture of the processor.

5. A method according to claim 4, further comprising the steps of forming an image of the mask on a semiconductor wafer by exposing the wafer to radiation using the mask and developing the exposed wafer to form a pattern on the wafer in accordance with the image.

6. A method according to claim 3, further comprising the steps of exposing a semiconductor wafer to an electron beam in accordance with the fourth data and developing the exposed wafer to form a pattern on the wafer in accordance with the fourth data.

7. A method according to claim 5, further comprising the step of processing the wafer to form the processor on and/or in the wafer.

8. A method according to claim 7, further comprising the step of cutting the wafer into one or more die, each die forming the processor.

9. A method according to claim 8, further comprising the step of testing the or each die.

10. A method according to claim 8, further comprising the step of packaging the or each die.

11. A method according to claim 3, further comprising the step of downloading the fourth data into a programmable logic array in order to configure the programmable logic array as the processor.

12. A method according to claim 1, further comprising the steps of receiving fifth data defining a logic arrangement of logic of an interface for an external apparatus and processing the fifth data with the second data to generate the third data.

13. A method according to claim 1, wherein the step of receiving the second data comprises receiving data defining a logic arrangement of an address decoder for asserting a chip select signal in response to addresses provided by the processor core.

14. A method according to claim 1, wherein the step of receiving the second data comprises receiving data defining a logic arrangement of a bus arbitration unit for arbitrating between competing requests for access to a memory device.

15. A method according to claim 14, wherein the step of receiving the user specification comprises receiving data specifying the number of wait states for the or each memory device, respectively, to be inserted by the bus arbitration unit when performing a memory access to the or each memory device and wherein the logic arrangement of the bus arbitration unit is operable to insert wait states into a memory access in accordance with the user specification.

16. A method according to claim 1, wherein the step of receiving the second data comprises receiving data defining a logic arrangement of a program bus, a data bus and a shared bus for interfacing the processor core to one or more memory devices.

17. A method according to claim 16, wherein the step of receiving second data comprises receiving data defining a multiplexer for multiplexing either a data space access or a program space access onto the shared bus.

18. A method according to claim 16, wherein the step of receiving the second data comprises receiving data defining a logic arrangement of an address mapping unit for mapping an address specified by the processor core to a different address on the shared bus and wherein the user specification further specifies an address mapping to be performed by the mapping unit.

19. A method according to claim 18, wherein the logic defining the mapping unit is operable to map the address of a data space access on the shared bus.

20. An apparatus for designing a processor for use in an integrated circuit, wherein the processor comprises a processor core f or executing a program comprising a sequence of program instructions selected from a predetermined instruction set, and a memory management unit for interfacing the processor core with one or more memory devices, the apparatus comprising:
a first receiver operable to receive first data defining a logic arrangement of the processor core;
a second receiver operable to receive second data defining a generic logic arrangement of the memory management unit, wherein the generic logic arrangement comprises logic defining a Harvard interface, having separate buses for performing instruction memory accesses and data memory accesses, between the processor core and one or more memory devices and logic defining a von Neuman interface, having a common bus for performing instruction memory accesses and data memory accesses, between the processor core and one or more memory devices;
a third receiver operable to receive a user specification of a Harvard interface or a von Neuman interface for the memory management unit for the or each memory device; and
a processor operable to process the second data in accordance with the received user specification to generate third data defining a logic arrangement of the memory management unit in accordance with the user specification.

21. An apparatus according to claim 20, further comprising a second processor operable to process the first data and the third data to generate fourth data defining a physical arrangement of the processor.

22. An apparatus according to claim 21, further comprising apparatus operable to manufacture a mask from the fourth data for use in exposing a semiconductor wafer to radiation during the manufacture of the processor.

23. A computer program product comprising processor executable instructions defining a program for use in a computer based method of designing a processor for use in an integrated circuit, wherein the processor comprises a processor core for executing a program comprising a sequence of program instructions selected from a predetermined instruction set, and a memory management unit for interfacing the processor core with one or more memory devices, the program comprising code for:
receiving first data defining a logic arrangement of the processor core;
receiving second data defining a generic logic arrangement of the memory management unit, wherein the generic logic arrangement comprises logic defining a Harvard interface, having separate buses for performing instruction memory accesses and data memory accesses, between the processor core and one or more memory devices and logic defining a von Neuman interface, having a common bus for performing instruction memory accesses and data memory accesses between the processor core and one or more memory devices;
receiving a user specification of a Harvard interface or a von Neuman interface for the memory management unit for the or each memory device; and
processing the second data in accordance with the received user specification to generate third data defining a logic arrangement of the memory management unit in accordance with the user specification.
